(19) United States
(12) Patent Application Publication
(10) Pub. No.: US 2008/0172332 A1
(43) Pub. Date: Jul. 17, 2008

(54) Check Recognition System

(76) Inventors: Edward Tsang, Chatsworth, CA (US); Andrew X. Lamparello, Tega Cay, SC (US)

Correspondence Address: Robert A. Blaha;SMITH FROHWEIN TEMPEL, GREENLEE BLAHA LLC, P.O. BOX 88148, Atlanta, GA, 30346, US

(21) Appl. No.: 11/622,047

(22) Filed: Jan. 11, 2007

(51) Int. Cl. G06Q 40/00

(52) U.S. Cl. 705/45

(57) ABSTRACT

A method, system, and computer readable storage to implement a method to determine flow schedules for processing a check presented at a bank by a patron. The flow schedule can be determined by using a routing number associated with the check and then looking up the routing number in a database in order to determine whether the check is an on-us check or transit check. The system can further determine whether a transit check is a local or non-local check based on whether the bank uses the same check processing center as the paying financial institution of the check. The type of check deposited by a patron affects the flow schedule and hence the information relayed to the patron. The flow schedule also varies in accordance with whether the patron is a customer of the bank and other factors.

### BACKGROUND OF THE INVENTION

1. Field of the Invention

The present inventive concept relates generally to a system and method for check processing. More particularly, the inventive concept relates to a system, method, and computer-readable storage medium that enables improved check depositing, processing and cashing.

2. Description of the Related Art

Currently, when bank patrons desire to physically deposit a check into a bank, the patron typically walks up to a teller, endorses the check, and presents the check to the teller with a deposit slip. The teller will then accept the check and give the patron a receipt for the transaction. However, the teller typically does not always have accurate knowledge of the processing time that it will take for the check to clear.

In addition, when a patron wishes to cash a check at a bank, sometimes this check may be refused by the bank for numerous reasons. It would be preferable for the patron if the bank would be able to cash his or her check immediately.

Therefore, what is needed is an improved check processing and cashing system which overcomes the aforementioned drawbacks.

### SUMMARY OF THE INVENTION

It is an aspect of the present inventive concept to provide a system, method, and computer readable storage medium to improve efficiency of check transactions.

The above aspects can be obtained by a method that includes (a) receiving, by a teller, a check from a patron in a bank; (b) identifying a routing number associated with the check to a computer implementing the method; (c) determining, using an electronic database, a type of the check using the routing number, the type reflecting different flow schedules; and (d) outputting, based on the type, a particular flow schedule regarding when funds from the check will be available to the patron.

The above aspects can also be obtained by a method that includes (a) maintaining, by a bank, a list of approved issuers; (b) receiving, by a teller, a check from a patron in a bank for cashing; and (c) determining if an issuer of the check is on the list of approved issuers, and if the issuer of the check is on the list of approved issuers then honoring the check by the bank.

The above aspects can also be obtained by a method that includes (a) receiving, by a teller, a transit check from a patron in a bank for cashing; (b) determining that the patron has an account with the bank and confirming that the account with the bank has at least equal funds to match an amount of the check; (c) instituting a hold of the amount of the check in the patron's account; (d) cashing the check; and (e) waiting until the check clears or is returned, and if the check clears, then releasing the hold on the patron's account.

The above aspects can also be obtained by a method that includes (a) maintaining, by a bank, a list of VIP customers; (b) receiving, by a teller, a check from a patron in a bank for cashing; and (c) determining if the patron is on the list of VIP customers, and if the patron is on the list of VIP customers then honoring the check by the bank.

Other systems, apparatuses, methods and advantages will be or will become apparent to one skilled in the art upon examination of the following figures and detailed description. All such additional systems, apparatuses, methods and advantages are protected by the accompanying claims.

### BRIEF DESCRIPTION OF THE DRAWINGS

Further features and advantages of the present inventive concept, as well as the structure and operation of various embodiments of the present inventive concept, will become apparent and more readily appreciated from the following description of the preferred embodiments, taken in conjunction with the accompanying drawings of which:

FIG. 1 is a flowchart illustrating an exemplary method of depositing a check at a bank, according to an embodiment;

FIG. 2 is a block diagram illustrating components used to process check recognition technology, according to an embodiment; and

FIG. 3 is a flowchart illustrating an exemplary procedure of approving a check for immediate cashing, according to an embodiment.

FIG. 4 is a schematic diagram illustrating an embodiment of a bank computer.

### DESCRIPTION OF THE PREFERRED EMBODIMENTS

Reference will now be made in detail to the presently preferred embodiments of the inventive concept, examples of which are illustrated in the accompanying drawings, wherein like reference numerals refer to like elements throughout.

There are two operations a patron can request when physically presenting a check to a teller at a bank. The first operation is depositing the check into the patron's own bank account, and the second operation is cashing the check to receive instant cash funds in exchange for the check.

The present general inventive concept relates to a method, system, and computer readable storage to implement a check processing system. When a patron deposits a check into his own account, an accurate flow schedule for the clearing of funds for that check can be immediately determined and conveyed to the patron.

All checks have a routing number which identifies the bank associated with the check and is used to help process the check. The routing number on a check can be used to determine whether the check is an “on-us check.” An on-us check is a check that is drawn from the same bank that the check is being presented. For example, if a patron walks into “Bankland Bank” and presents a check (either for deposit or for cashing) that is drawn on “Bankland Bank” (e.g., the check has “Bankland Bank” on it and Bankland Bank is the paying financial institution). This check is an on-us check because the same bank that is the paying financial institution on the check is also being asked to receive the check (for depositing or cashing). This bank should typically have access to all information relating to this check, such as the writer's account info, his or her balance, etc. Typically, an on-us check takes no more than one day to clear. It is possible that a bank may have more than one routing number that still refers to the same bank (or banking association) and thus all of these routing numbers would still be considered an on-us check to the bank where the check is physically presented.

A local check is a check that is not an on-us check and where the paying financial institution (bank) on the check is supported by the same check processing center (CPC) that the instant bank uses where the check is being physically presented. For example, if a check is written on a Bank A check and is presented to Bank B, and both banks use the same CPC, then the check is considered a local check to Bank B.

A non-local check is a check that is not an on-us check and where the paying financial institution (bank) on the check is not supported by the same check processing center (CPC) that the instant bank uses where the check is being physically presented.

A transit check is a check that is not an on-us check. That is, a transit check is drawn on another bank from where it is being presented. A transit check can either be a local check or a non-local check.

The determination of whether a check is on-us, local, or non-local, can be performed using the check's routing number. The routing number can be used to identify the check's CPC. This can be performed, for example, using a database or a table which contains a list of routing numbers and their respective CPCs.

For example, the primary routing number associated with a bank is stored in a branch table. An exception routing table includes exception routing numbers, in a separate table from the branch table. The exception routing table identifies additional on-us routing numbers. The branch table and the exception routing table are used to determine whether a check is an on-us check or not. If it is not an on-us check, the first 4 digits of the routing number on the check can be used to determine the check's CPC. This can be performed using a database or table which contains a list of routing numbers (first 4 digits only) and their respective CPCs. Table I below illustrates an exemplary table of routing numbers and respective CPCs.

TABLE I

| Routing Number | CPC |
|---|---|
| 122000661 | on-us (assuming this is the routing number of the |
| | bank) |
| 1220xxxxx | 1 |
| 1221xxxxx | 1 |
| 1222xxxxx | 1 |
| 0610xxxxx | 2 |
| 0710xxxxx | 3 |

For example, using Table I, a check with a routing number of 1200xxxxx uses check processing center 1. Note that it is possible that more than one routing number can still use the same CPC (e.g., 1220xxxxx, 1221xxxxx and 1222xxxxx, all use the same CPC #1).

As a further example, if Bankland Bank has routing number 122299999 and uses CPC 1, and someone walks into Bankland Bank and presents a check from a Crazy Bank account with routing number 122199933, since that routing number uses CPC 1 also, the check is considered to be a local check since the check is associated with the same CPC as the bank the check is presented. It is also noted that since these two banks are different, the Crazy Bank check would not be considered an on-us check to Bankland Bank. If instead, the Crazy Bank check had routing number 061033333, then from Table I, it is determined that the CPC is 2, which is different from Bankland Bank's CPC, and thus this check would be considered a non-local check to Bankland Bank. The above described steps for determining whether a check is local or non-local check can be overridden by adding specific local and non-local routing numbers in the exception routing table. For example, if routing number 061033333 was defined as a local routing number in the exception routing table, any Crazy Bank check with a routing number of 061033333 would be considered as a local check instead of a non-local check to Bankland Bank.

When a patron presents a check to a teller, the teller can type in that check's routing number in order for the system to determine the check's status (on-us, local, or non-local). Alternatively, the teller can scan the check and the routing number can be extracted optically, magnetically, or using any other known method for acquiring a check routing number.

There are regulatory and bank guidelines regarding when deposited checks will clear. Whether the type of check is on-us, local, or non-local, typically determines how long the check will take to clear (the “flow schedule”). The teller's terminal can process the check, and based on the type of check (determined using the routing number), the terminal can output to the teller a flow schedule that the check will clear. A flow schedule can be a definite time that the check will clear in full (e.g., all funds from the check will be available to the patron in his or her account), or in some cases part of a check's funds will be available on a certain date (e.g., immediately) and the remainder of the check's funds will be available at a later date (e.g., in five days). For example, an on-us check for an amount over $5,000 may have the following flow schedule: $100 is available immediately, the next $900 will be available after one business day, and the remaining amount will be available after six business days. There can be different flow schedules for different types of checks. Optionally, different amounts of the checks can also have different flow schedules among their respective type as well. For example, a local check under $5,000 may have a different flow schedule than a local check over $5,000.

For example, an on-us check may take 24 hours to clear, a local check may take 48 hours to clear, and a non-local check may take a week to clear. If a patron deposits cash into his or her account, cash may be treated as an on-us check, and 100% of the cash may not be available immediately. Of course, these dates may differ depending on laws and bank rules/procedures. The flow schedules are configurable by the users via parameters stored in a rules database.

It is noted that there may be exceptions to the general flow schedule rules. One or more conditions of the depositor's and the issuer's respective accounts can trigger exceptions to processing rules. For example, if the depositor's account is new, this may lengthen the hold time of the check being deposited (e.g., an extension of three days). If the issuer's account is overdrawn or when the issuer is a party that has been identified as a high risk, the receiving bank may lengthen the hold time. Also, if the check is a returned check (already deposited once and returned for insufficient funds), this may also lengthen the hold time of the check. In addition, a check amount or one or more conditions at the bank can trigger other extensions to the general flow schedule rules. If the deposit is greater than a predetermined amount (e.g., $5,000), then the hold time may be adjusted. If there is an emergency declared at the bank, this can also lengthen the hold time. The exception hold schedules can be modified by operators as needed to reflect government guidelines/regulations as well as bank procedures/rules, which can be changed at various times.

Thus, by using a check's routing number to determine a type of check, a teller can typically convey to a patron an accurate flow schedule for when the check will clear.

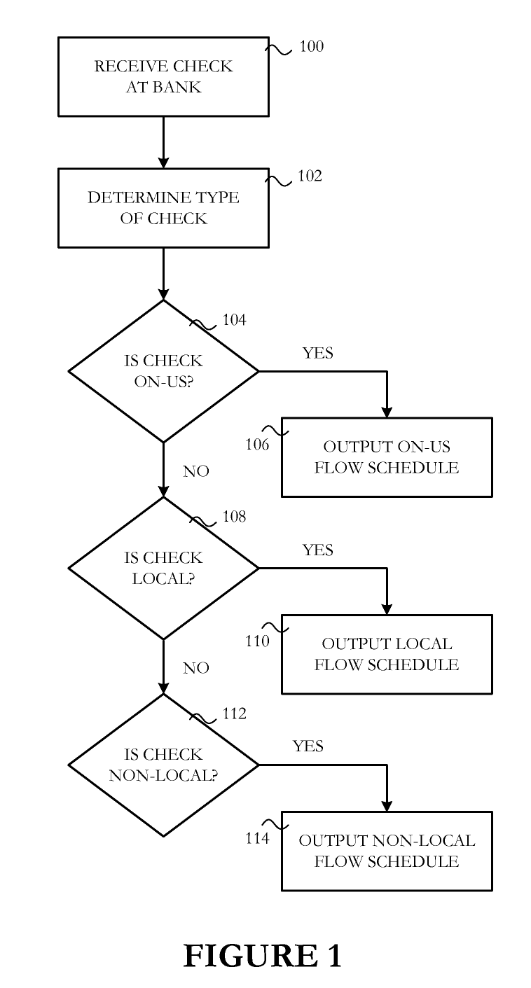

FIG. 1 is a flowchart illustrating an exemplary method of depositing a check at a bank, according to an embodiment.

The method can start with operation 100, which receives a check at a bank. This can be performed as known in the art, wherein a patron walks into a bank and presents a check for deposit.

The method can proceed to operation 102, which determines the type of check (e.g., on-us, local, non-local). This can be done using the check's routing number (as well as knowing the bank's own routing number(s) and CPC) as described herein.

The method can proceed to operation 104, which determines if the check is “on-us.” If the check is drawn from the same banking institution (not necessarily the same branch) that the check is being received at (in operation 100), then the check is on-us. If the check is on-us, then the method can proceed to operation 106, which outputs the on-us check flow schedule. The output can be on a terminal screen to the teller, upon which the teller can verbally inform the patron of the flow schedule, or the flow schedule can be printed on the receipt ticket. For example, the teller can tell the patron who presents an on-us check, “the first $100 will be available right now, but in 24 hours the remaining funds from this check should be available.” Of course, this still isn't any kind of guarantee to the patron that this will take place, as unexpected circumstances can still take place (a malfunction, etc.).

If the determination in operation 104 determines that the check is not an on-us check, then the method can proceed to operation 108, which determines if the check is local.

If the determination in operation 108 determines that the check is local, then the method can proceed to operation 110, which outputs a local flow schedule. For example, the teller may inform the patron that half of the funds will be available after 24 hours, and the remaining funds will be available after five business days (assuming the check clears). The local flow schedule (as well as the on-us and non-local) can be retrieved from a database. The teller can override the system recommended flow schedule and use the exception hold schedule instead (such as the check amount or any related information).

If the determination in operation 108 determines that the check is not local, then the method can proceed to operation 114, which outputs a non-local flow schedule. Typically, the non-local flow schedule would take longer to process than the on-us or local checks. The non-local flow schedule can be retrieved from a database. Again, the teller can override the system recommended flow schedule and use the exception hold schedule instead (such as the check amount or any related information).

It is noted that the operations in FIG. 1 can be performed in any logical order. Furthermore, other logical constructs can be implemented as well to effectuate a same or similar logic. For example, a single decision block can determine the type of check, and from there the respective operation (106, 110, or 114) can be performed. All of the flow schedules can be outputted to the teller and/or the patron either audibly or in print. If outputted to the teller, the teller typically would relay the information to the patron.

Thus, by using the method described above, a bank can give a bank patron who presents a check for deposit more accurate information on the flow schedule for when that check's funds will be cleared. By determining the type of check, the check's flow schedule can be identified even before it is processed, and thus, outputted to the teller and/or the patron. A flow schedule may be complex, for example, if a $10,000 local check is deposited, $100 of the check may be available immediately, $4900 of the check may be available after three days, and the remaining $5000 of the check may be available after five days, all assuming there is no problem with the check. Table II is an exemplary table of how a type of a check can be used, along with other information (for example, but not limited to, the check amount) to determine the check's flow schedule. Of course, Table II is just presented for exemplary purposes only.

TABLE II

| Check type | amount | flow schedule |
|---|---|---|
| On-us | <$100 | available immediately |
| On-us | >$100 | $100 available immediately, the remaining |
| | | available after 24 hours. |
| Local | <$5000 | first $100 available immediately, the |
| | | remaining amount available after three days |
| Local | >$5000 | First $100 available immediately, another |
| | | $4900 available after three days, and the |
| | | remaining available after five days |
| Non-local | any | $100 available immediately, the remaining |
| | | available after 5 days. |

A rules table such as that exemplified in Table II can be stored in a database and can be modified by operators as needed to reflect government guidelines/regulations as well as bank procedures/rules.

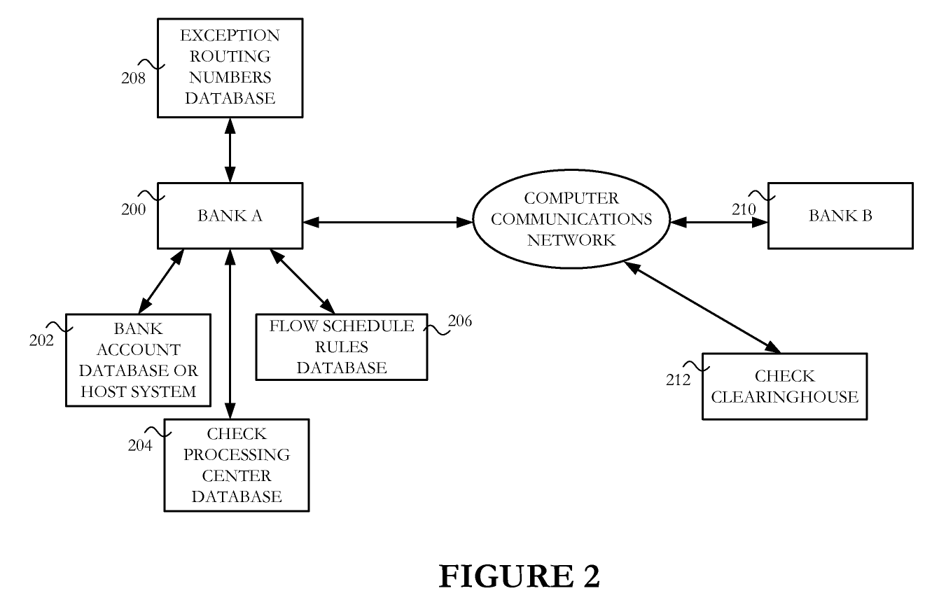

FIG. 2 is a block diagram illustrating components used to process check recognition technology, according to an embodiment.

Bank A 200 can access a bank account database (or host system) 202 which stores information regarding each of their customer's account. Bank A 200 can also access a check processing center database 204, which stores routing numbers, their respective CPC, and any other related information. Bank A can also access an exception routing numbers database 208, which overrides the default routing rules. Bank A can also access a flow schedule rules database 206, which stores all of the rules associated with the different types of checks, and also sub-rules associated with the different types of checks (e.g. different amounts or other characteristics may have their own flow rules). It is noted that these and other databases may exist physically at Bank A or may be remote and accessible by Bank A using a computer communications network. The databases may also exist as a single database or in many different parts spread across different locations and/or networks. The actually physical implementation of these databases and how the records are stored is not important and subject to an almost infinite number of configurations.

Thus if a patron writes a check using bank B 210, and presents it at bank A 200, bank A can determine the type of the check using the check processing center database 204 and exception routing database 208. Based on the type of check, the patron can be told the flow schedule using information from the flow schedule rules database 206. If the check was an on-us check, Bank A could clear the check internally. However, in this case, since Bank B is a different bank than Bank A, the check is not an on-us check. The check can then be sent to a check clearinghouse 212 which can be used in order to facilitate processing of transit checks, as known in the art.

In a further embodiment, checks can be cashed using improved procedures which can result in a higher success rate. Bank patrons of course prefer that checks they present to the bank are honored and cashed immediately, as opposed to checks being returned as having insufficient funds in the writer's account.

If a check is an on-us check, then the bank can immediately know if there are sufficient funds to cover the check.

If a check is not an on-us check (a transit check), then a bank may be reluctant to immediately cash such a check for a patron for fear the check may not be honored by the paying financial institution. However, additional security measures can be implemented in order to attempt to honor a transit check.

If the patron desires to cash a transit check and the patron currently possesses an account with the bank, then this account can be used to hold funds (typically an identical amount, although not required to be so) while the transit check clears. This can be considered a “recourse account.”

In addition, if the issuer of the check (writing party) is on the bank's approved list, then the check may be cashed immediately notwithstanding they are transit checks. For example, if a check is written by a large, well established, company, such company would logically be on the approved list and their check can be cashed immediately.

Moreover, even if the transit check is not written by an approved issuer, and the patron does not have a recourse account, then the bank may still cash the check for the patron if the patron is considered a “VIP” customer. Which customers/patrons a bank considers to be their VIP customers is at the discretion of the bank and/or their manager(s)/supervisor(s).

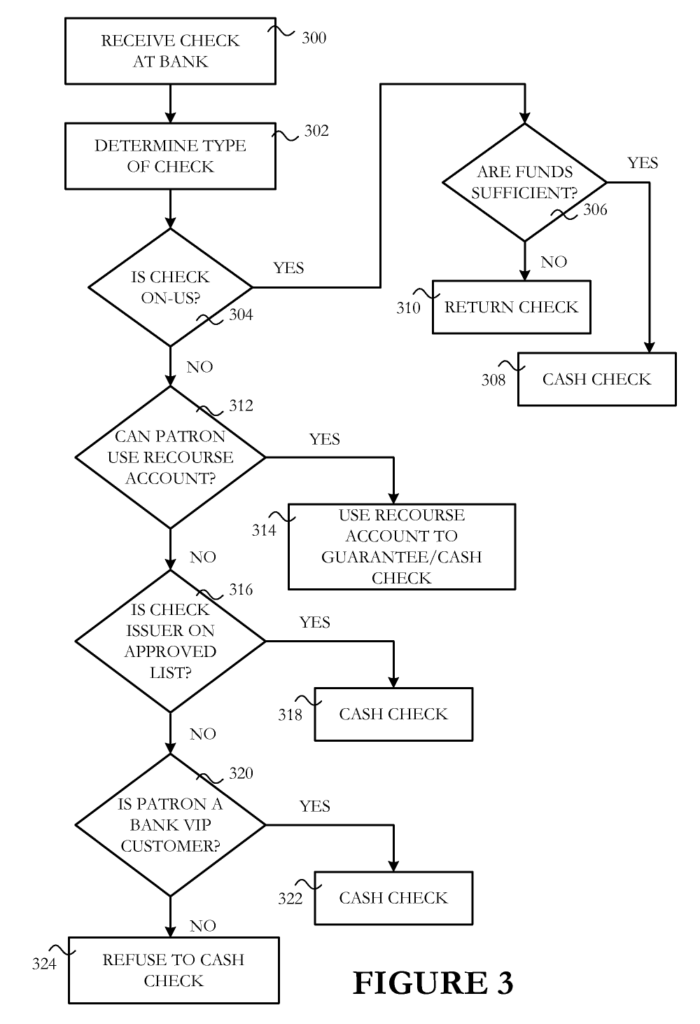

FIG. 3 is a flowchart illustrating an exemplary procedure of approving a check for immediate cashing, according to an embodiment.

The method can start with operation 300, which receives a check at a bank from a patron by a teller.

The method can proceed to operation 302, which determines the type of check, whether it is an on-us check or a transit check. This can be done as described herein.

If the determination in operation 302 determines that the check is an on-us check, then the method can proceed to operation 306, wherein the bank determines if there are sufficient funds in the account associated with the check to cover the amount of the check.

If the determination operation 306 determines that there are sufficient funds, then the method can proceed to operation 308, wherein the teller can cash the check and the method ends.

If the determination in operation 306 determines that there are not sufficient funds to cover the check, then the method can proceed to operation 310, which returns the check because there are insufficient funds to cover it.

If the determination in operation 304 determines that the check is not an on-us check (and hence is a transit check), then the method can proceed to operation 312, which determines if the patron can use a recourse account. If the patron currently has an account with the bank, and has sufficient funds to cover the amount of the check, then the bank can use the patron's account as a recourse account. If the patron meets these criteria and agrees to do this, then the method can proceed to operation 314, wherein the bank can use the patron's account as a recourse account. The bank can freeze (or hold or lock) that amount (equal to the check) in the patron's bank account until the check clears. If the check clears, then the amount can be unfrozen. If the check does not clear, then the check can be returned to the patron and the funds frozen can be deducted from the patron's account.

If the determination in operation 312 determines that a recourse account is not an option, then the method can proceed to operation 316, which determines if an issuer of the check is on an approved list. A bank can maintain an approved list of issuers (writers) of checks and would be confident these checks would not bounce. The approved list may contain sister institutions to the bank that the bank trusts, government agencies, large respected corporations, or any other companies and/or individual that the bank has determined to be trustworthy.

If the determination in operation 316 determines that the issuer is on the approved list, then the method can proceed to operation 318, wherein the bank can then cash (honor) the check. If the check is drawn from an account with insufficient funds when the check is presented for payment, the bank itself may have to absorb the loss and then may try to collect the deficiency from the writer and/or the patron.

If the determination in operation 316 determines that the issuer of the check is not on the approved list, then the method can proceed to operation 320, which determines if the patron is a VIP customer of the bank. The bank can maintain a list of VIP customers based on such factors as their banking history, profession, length of time with the bank, or any other characteristic of the patron. A manager/supervisor may also have the authority to deem a patron a VIP customer instantly, even though the patron may not currently be on the VIP list.

If the determination in operation 320 determines that the patron is a VIP customer, then the method can proceed to operation 322, wherein the bank would cash the check.

If the determination in operation 320 determines that the patron is not a VIP customer, then the method can proceed to operation 324, wherein the bank can refuse to cash the check and can return the check to the patron. This of course does not mean that the check is bad and will be refused if it is deposited into the patron's own bank account.

It is noted that any of the operations described herein can be performed in any sensible order. Further, any operations may be optional. Also, any feature or embodiment described herein can be combined with any other. Any method described herein also includes hardware needed to implement the method, and also any software that can be stored on a computer readable storage medium which can instruct the hardware to perform the method.

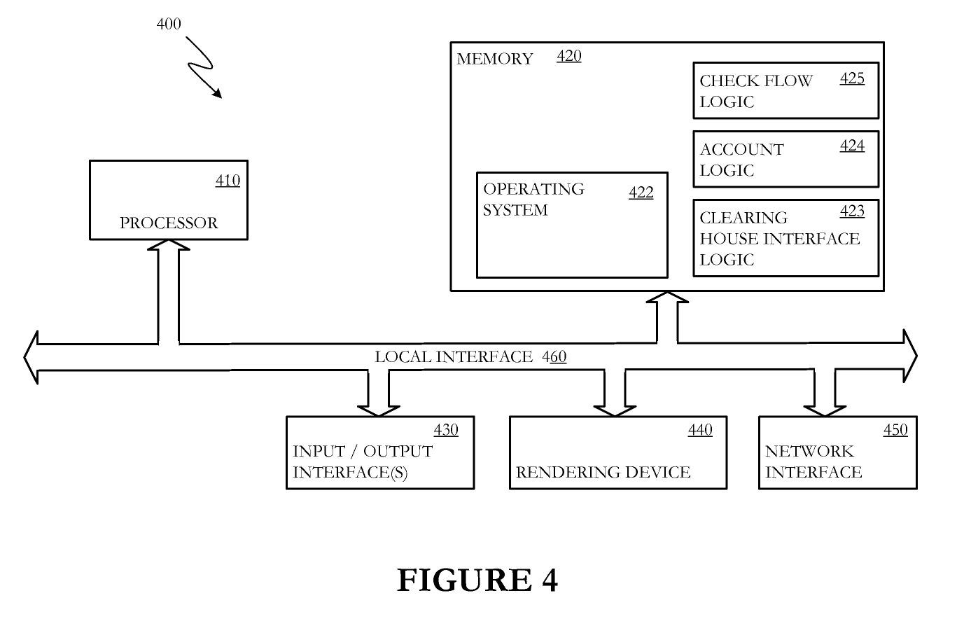

FIG. 4 is a schematic diagram illustrating an embodiment of bank computer 400. Generally, in terms of hardware architecture, as shown in FIG. 4, bank computer 400 is a general purpose computing device or other hardware device that includes processor 410, memory 420, input/output (I/O) interface(s) 430 and network interface 450. Processor 410, memory 420, I/O interface(s) 430, rendering device 440 and network interface 450 are communicatively coupled via local interface 460. The local interface 460 can be, for example but not limited to, one or more buses or other wired or wireless connections, as is known in the art. The local interface 460 may have additional elements, which are omitted for simplicity, such as controllers, buffers (caches), drivers, repeaters, and receivers, to enable communications. Further, the local interface 460 may include address, control, power and/or data connections to enable appropriate communications among the aforementioned components. Moreover, local interface 460 provides power to each of the processor 410, memory 420, I/O interface(s) 430, rendering device 440 and network interface 450 in a manner understood by one of ordinary skill in the art.

Processor 410 is a hardware device for executing software (i.e., programs or sets of executable instructions), particularly that stored in memory 420. The processor 410 can be any custom made or commercially available processor, a central processing unit (CPU), an auxiliary processor among several processors associated with bank computer 400, a semiconductor based microprocessor (in the form of a microchip or chip set), or generally any device for executing instructions.

Memory 420 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disk read-only memory (CD-ROM), etc.). Moreover, memory 420 may incorporate electronic, magnetic, optical, and/or other types of storage media. Note that memory 420 can have a distributed architecture, where various components are situated remote from one another, but can be accessed by processor 410.

The software in memory 420 may include one or more separate programs, each of which comprises an ordered listing of executable instructions for implementing logical functions. In the example embodiment illustrated in FIG. 4, the software in memory 420 includes operating system 422, clearing house interface logic 423, account logic 424, and check flow logic 425. The operating system 422 essentially controls the execution of other computer programs and provides scheduling, input-output control, file and data management, memory management, communication control and related services.

Clearing house interface logic 423 includes one or more programs and one or more data elements that enable bank computer 400 to communicate with one or more check clearing house applications operative on a computing device coupled to bank computer 400 via a data communications network. Clearing house interface logic 423 may include one or buffers and parameter stores for holding configuration information and or data as may be required to interface with any number of devices that may be coupled to bank computer 400. Clearing house interface logic 423 further includes logic that is responsive to one or more inputs that are applied via input/output interfaces 430.

Account logic 424 includes one or more programs and one or more data elements that enable bank computer 400 to identify and manage a select bank account associated with one or more customers. Account logic 424 may include one or more buffers and parameter stores for holding configuration information and or data as may be required to identify or otherwise manage the select bank account. Account logic 424 interacts with clearing house interface logic 423 and check flow logic 425 to enable various check processing steps in association with the select bank account.

Check flow logic 425 includes one or more programs and one or more data elements that enable bank computer 400 to implement one or more of the above described check cashing flow processes. Check flow logic 425 may include one or more buffers and parameter stores for holding configuration information and or data as may be required to implement a select flow schedule rule.

Clearing house interface logic 423, account logic 424 and check flow logic 425 are source programs, executable programs (object code), scripts, or other entities that include a set of instructions to be performed. When implemented as source programs, the programs are translated via a compiler, assembler, interpreter, or the like, which may or may not be included within memory 420, to operate properly in connection with O/S 422.

I/O interface(s) 430 includes multiple mechanisms configured to transmit and receive information via bank computer 400. These mechanisms support human-to-machine (e.g., a keyboard) and machine-to-human information transfers. Such human-to-machine interfaces may include touch sensitive displays or the combination of a graphical-user interface and a controllable pointing device such as a mouse. Moreover, these mechanisms can include voice-activated interfaces that use a microphone or other transducer.

Rendering device 440 enables bank computer 400 to communicate information with various network coupled display devices such as printers, plotters, monitors, etc. Rendering device 440 is a hardware device that is responsible for producing graphical abstractions in accordance with one or more programs and data. Rendering device 440 receives instructions and data from processor 410 and memory 420 and generates one or more output signals suitable for directing the presentation of information via a designated output device.

Network interface 450 enables bank computer 400 to communicate with various network-coupled devices, including other network-coupled devices. Network interface 450 performs a variety of functions including, for example the signal conditioning and format conversions to communicate data. Preferably, network interface 450 is compatible with one or both of the Gigabit Ethernet standards (i.e., IEEE 802.3z Fiber Optic Gigabit Ethernet and IEEE 802.3ab Twisted-Pair Gigabit Ethernet) and the TCP/IP protocol. It should be understood that other data-network interfaces compatible with other network protocols including wireless protocols may also be used.

When bank computer 400 is in operation, the processor 410 is configured to execute software stored within the memory 420, to communicate data to and from the memory 420, and to control operations of the bank computer 400 pursuant to the software. The clearing house interface logic 423, account logic 424, check flow logic 425, and the O/S 422, in whole or in part, but typically the latter, are read by the processor 410, perhaps buffered within the processor 410, and then executed.

When clearing house interface logic 423, account logic 424 and check flow logic 425 are implemented in a memory, as is shown in FIG. 4, it should be noted that these programs and data elements can be stored on any computer-readable medium for use by or in connection with any computer related system or method. In the context of this document, a “computer-readable medium” can be any means that can store, communicate, propagate, or transport program(s) for use by or in connection with an integrated circuit design tool. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM (electronic), a ROM (electronic), an erasable programmable read-only memory (EPROM), an electrically erasable programmable read-only memory (EEPROM), or Flash memory) (electronic), an optical fiber (optical), and a CDROM (optical). Note that the computer-readable medium could even be paper or another suitable medium upon which the program is printed, as the program can be electronically captured, via optical scanning of the paper or other medium, then compiled, interpreted or otherwise processed in a suitable manner if necessary, and then stored in a computer memory.

In an alternative embodiment, where one or more of the clearing house interface logic 423, account logic 424, and check flow logic 425 are implemented in hardware, the clearing house interface logic 423, account logic 424, and check flow logic 425 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field-programmable gate array (FPGA), flip-flops, etc.

The foregoing description has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the present systems and methods that improve check processing. All such modifications and variations are within the scope of the appended claims when interpreted in accordance with the breadth to which they are fairly and legally entitled.

What is claimed is:

1. A computer implemented method to determine check processing time by a bank, the method comprising:
receiving, by a teller, a check from a patron in a bank for deposit purpose;
identifying a routing number associated with the check to a computer implementing the method;
determining, using an electronic database, a type of the check using the routing number; and
outputting, based on the type, a particular flow schedule regarding when funds from the check will be available to the patron responsive to the particular flow schedule.

2. The method as recited in claim 1, wherein if a paying financial institution of the check is the bank, then the type of the check is determined to be on-us.

3. The method as recited in claim 1, wherein if a paying financial institution of the check is other than the bank, and the check processing center associated with the check is identical to the check processing center associated with the bank, then the type of check is determined to be local.

4. The method as recited in claim 1, wherein if a paying financial institution of the check is other than the bank, and the check processing center associated with the check is not identical to the check processing center associated with the bank, then the type of check is determined to be non-local.

5. The method as recited in claim 1, future comprising, before the outputting:
retrieving the particular flow schedule based on the type of the check and exception conditions.

6. A computer implemented method to determine check cashing by a bank, the method comprising:
receiving, by a teller, a check from a patron in a bank for check cashing purpose;
identifying a routing number associated with the check to a computer implementing the method;
determining, using an electronic database, a type of the check using the routing number; and
outputting, based on the type, the validation steps required to cash a check for the patron.

7. The method as recited in claim 6, wherein if a paying financial institution of the check is the bank, then the type of the check is determined to be on-us.

8. The method as recited in claim 7, wherein if the type of the check is on-us and the patron is presenting the check for cash, then determining if funds for the check are available from an account the check is drawn from, and if the funds are available, then paying the patron that presented the check.

9. The method as recited in claim 6, wherein if a paying financial institution of the check is other than the bank, then the type of the check is determined to be transit.

10. The method as recited in claim 9, further comprising:
maintaining, by a bank, a list of approved issuers;
receiving, by a teller, a check from a patron in a bank for cashing; and
determining if an issuer of the check is on the list of approved issuers, and if the issuer of the check is on the list of approved issuers then honoring the check by the bank.

11. The method as recited in claim 10, wherein when the issuer of the check is not on the list of approved issuers and the patron is a bank customer, querying a recourse account balance before approving the check for immediate cashing.

12. The method as recited in claim 11, further comprising:
receiving, by a teller, a transit check from a patron in a bank for cashing;
determining that the patron has an account with the bank and confirming that the account with the bank has at least equal funds to match an amount of the check;
instituting a hold of the amount of the check in the patron's account;
cashing the check; and
waiting until the check clears or is returned, and if the check clears, then releasing the hold on the patron's account.

13. The method as recited in claim 12, wherein if the check does not clear, then removing the amount of the check that is held in the patron's account.

14. The method as recited in claim 9, further comprising:
maintaining, by a bank, a list of VIP customers;
receiving, by a teller, a check from a patron in a bank for cashing; and
determining if the patron is on the list of VIP customers, and if the patron is on the list of VIP customers then honoring the check by the bank.

15. The method as recited in claim 14, wherein when the issuer of the check is not on the list of VIP customers, a bank manager has the discretion to approve the check for immediate cashing.
